(19) United States
(12) Patent Application Publication
(10) Pub. No.: US 2024/0159421 A1
(43) Pub. Date: May 16, 2024

(54) AIR CONDITIONING APPARATUS

(71) Applicant: SANDEN CORPORATION, Isesaki-shi, Gunma (JP)

(72) Inventors: Naotaka IWASAWA, Isesaki-shi, Gunma (JP); Akira KANEKO, Isesaki-shi, Gunma (JP); Yasuaki KANO, Isesaki-shi, Gunma (JP); Takahisa TOBE, Isesaki-shi, Gunma (JP); Yoshio KOWADA, Isesaki-shi, Gunma (JP)

(73) Assignee: SANDEN CORPORATION, Isesaki-shi, Gunma (JP)

(21) Appl. No.: 18/281,264

(22) PCT Filed: Mar. 22, 2022
(86) PCT No.: PCT/JP2022/013273

§ 371 Date: Sep. 8, 2023

(30) Foreign Application Priority Data
Mar. 24, 2021 (JP) 2021-050457

(51) Int. Cl. F24F 11/74

(52) U.S. Cl. CPC F24F 11/74

(57) ABSTRACT

An air conditioning apparatus includes a refrigerant circuit including a plurality of heat exchangers (a condenser and an evaporator), and an axial fan configured to send air to the heat exchangers. The refrigerant circuit and the axial fan are accommodated in a case. The heat exchangers are disposed in a direction orthogonal to an air flow direction, and the axial fan is disposed on one side of an arrangement direction of the heat exchangers, and supplies the air to the heat exchangers.

### CROSS-REFERENCE TO RELATED APPLICATIONS

This application is a U.S. National Stage Patent Application under 37 U.S.C. § 371 of International Patent Application No. PCT/JP2022/013273, filed on Mar. 22, 2022, which claims the benefit of Japanese Patent Application No. JP 2021-050457, filed on Mar. 24, 2021, the disclosures of each of which are incorporated herein by reference in their entirety.

### TECHNICAL FIELD

The present invention relates to an air conditioning apparatus.

### BACKGROUND ART

There has been known an air conditioning apparatus including a set of components required for air conditioning, such as a compressor, a condenser, an evaporator, and an expansion valve of a refrigerant circuit, and a blower, which are accommodated in an individual case (see Patent Literature 1 mentioned below).

Meanwhile, there has been proposed related art including a blowing side blower and an exhaust side blower, and a cool air room or a warm air room provided under an evaporator and a condenser disposed parallel to one another in a case, where the blowing side blower and the exhaust side blower direct the air having passed through the condenser or the evaporator from above to the cool air room or the warm air room, and then blow or discharge the air upward.

### CITATION LIST

### Patent Literature

PTL1: Japanese Patent Application Laid-Open No. 2020-83113

### SUMMARY OF INVENTION

### Problem to be Solved by the Invention

The air conditioning apparatus described above is reduced in size, and therefore can be space-saving and installed in a room of a house or in a vehicle compartment. In addition, considering measure against viral infectious disease, and reduction in the concentration of CO₂ in the room, it is required to locally or individually condition the air in the ventilated space. When the above-described air conditioning apparatus is used for local or individual air conditioning, the demand to reduce the size is further increased.

On the other hand, the above-described related art includes the space such as the cool air room and the warm air room in the case. Therefore, for the air conditioning apparatus accommodating the air conditioning components in the case, when a sufficient space for the air conditioning components is secured in order to attain desired air conditioning performance, the size of the apparatus should be increased.

In addition, the related art includes the two blowers on the blowing side and the exhaust side which occupy the space in the case, and therefore has a limitation on the reduction in the size of the case. To address this, it is conceivable that the number of the blowers is reduced to one, and the flow path is divided into a blowing side path and an exhaust side path. However, it is difficult to distribute the airflow between the evaporator and the condenser in the case at a given ratio. In addition, when one blower is disposed on the windward side of the evaporator and the condenser at the intermediate position of the arrangement direction of the evaporator and the condenser arranged in parallel in the case, a dead space is formed on each side of the space in which the blower is disposed in the arrangement direction. Accordingly, it is not possible to efficiently use the space to arrange the air conditioning components in the case.

The present invention has been proposed to solve the above-described problems. That is, it is therefore an object of the invention to provide an air conditioning apparatus capable of reducing in size by arranging air conditioning components without forming a dead space while distributing the air between two heat exchangers (an evaporator and a condenser) with use of one blower, when the air conditioning apparatus accommodates the components required for air conditioning in a case.

### Solution to Problem

To solve the above-described problems, the air conditioning apparatus according to the invention includes constitutions below.

An air conditioning apparatus includes a refrigerant circuit including a plurality of heat exchangers, and an axial fan configured to send air to the heat exchangers. The refrigerant circuit and the axial fan are accommodated in a case. The heat exchangers are disposed in a direction orthogonal to an air flow direction, and the axial fan is disposed on one side of an arrangement direction of the heat exchangers, and supplies the air to the heat exchangers.

### Effect of the Invention

According to the invention, it is possible to provide an air conditioning apparatus capable of reducing in size by arranging air conditioning components without forming a dead space while distributing the air between two heat exchangers with use of one blower.

### BRIEF DESCRIPTION OF DRAWINGS

FIG. 1 is a schematic perspective view illustrating the configuration of an air conditioning apparatus according to an embodiment of the invention: FIG. 1A is a schematic perspective view illustrating the appearance of the air conditioning apparatus; and FIG. 1B is a schematic perspective view illustrating the internal configuration of the air conditioning apparatus according to an embodiment of the invention;

FIG. 2 is a schematic perspective view illustrating the internal configuration of the air conditioning apparatus, part of which is see-through;

FIG. 3 illustrates the schematic configuration of the air conditioning apparatus: FIG. 3A is a top view illustrating the schematic configuration of the air conditioning apparatus; and FIG. 3B is a side view;

FIG. 4 illustrates the schematic configuration of a fan duct according to the embodiment: FIG. 4A is a front view illustrating the schematic configuration of the fan duct; FIG. 4B is a side view; and FIG. 4C is a rear view;

FIG. 5 illustrates a comparative example compared to the fan duct according to the embodiment: FIG. 5A is a front view illustrating the comparative example compared to the fan duct; FIG. 5B is a side view; and FIG. 5C is a rear view;

FIG. 6 illustrates the schematic configuration of the internal layout of the air conditioning apparatus to explain the air flow of an axial fan according to the embodiment: FIG. 6A is a front view illustrating the internal layout of the air conditioning apparatus; FIG. 6B is a side view; and FIG. 6C is a rear view; and

FIG. 7 illustrates a comparative example compared to the air flow of the axial fan according to the embodiment: FIG. 7A is a front view illustrating the comparative example compared to the air flow of the axial fan; FIG. 7B is a side view; and FIG. 7C is a rear view.

### DESCRIPTION OF EMBODIMENTS

Hereinafter, an embodiment of the invention will be described in detail with reference to the drawings. In the description below, the same reference number in different drawings denotes the same component with the same function, and duplicate description for each of the drawings is omitted accordingly. Here, in each of the front views, the right-and-left direction is indicated by X-axis, the front-to-back direction is indicated by Y-axis, and the up-and-down direction is indicated by Z-axis.

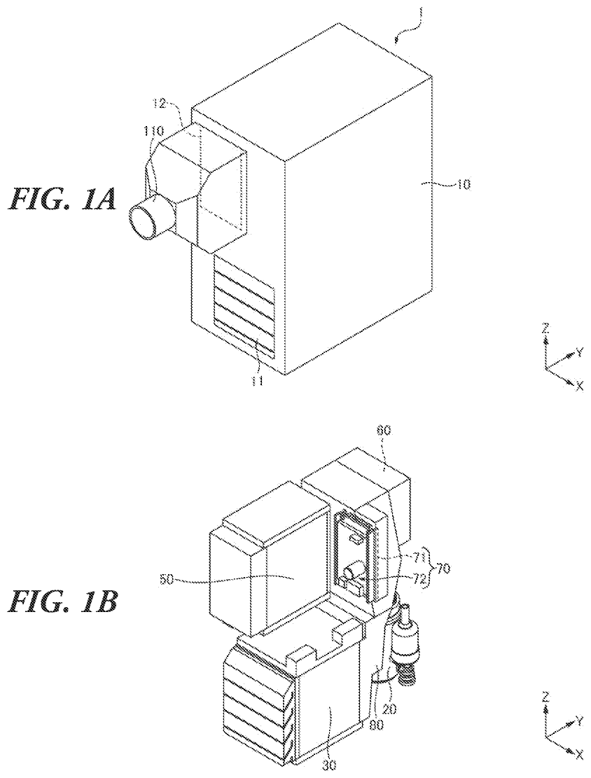

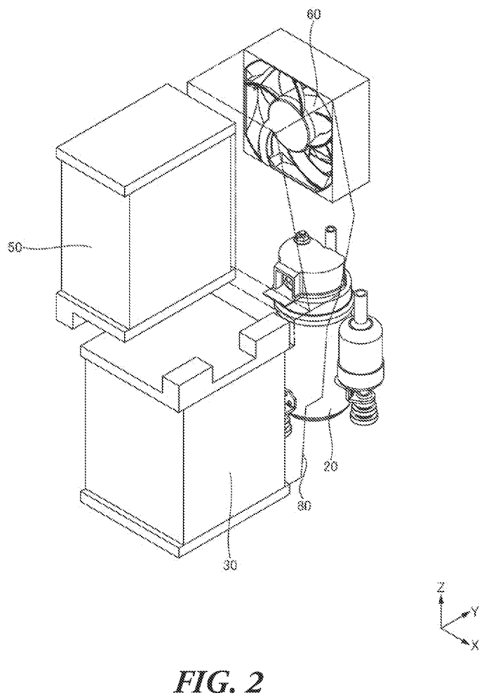

Now, an air conditioning apparatus 1 according to the present embodiment will be described. As illustrated in FIG. 1 and FIG. 2, the air conditioning apparatus 1 includes a compressor 20, a condenser (heat exchanger) 30, an evaporator (heat exchanger) 50, an axial fan 60, an inverter device 70, and a fan duct 80 in a case 10. Here, the compressor 20, the condenser 30, the evaporator 50, and an expansion valve (not illustrated) constitute a refrigerant circuit. Therefore, in the air conditioning apparatus 1, the refrigerant circuit including a plurality of heat exchangers (the evaporator 50 disposed on one side and the condenser 30 disposed on the other side of the arrangement direction), and the axial fan 60 configured to send the air to the heat exchangers are accommodated in the case 10. Here, in the air conditioning apparatus 1 according to the present embodiment, the evaporator 30 and the condenser 50 are arranged in parallel in the up-and-down direction (the Z-axis direction in the drawings). However, this is by no means limiting, but the evaporator 30 and the condenser 50 may be arranged in parallel in the right-and-left direction (the X-axis direction in the drawings).

The compressor 20, the condenser 30, and the evaporator 50 are connected to each other by pipes (not illustrated), and configured to allow refrigerant to flow therethrough.

### <Compressor 20>

The compressor 20 is configured to compress the refrigerant flowing through the pipes. The refrigerant is compressed to become high-pressure gas, passes through the pipe, and flows into the condenser 30.

### <Condenser 30>

The condenser 30 is a heat exchanger configured to perform a heat exchange between the refrigerant discharged from the compressor 20 and the air sent from the axial fan 60. The refrigerant is liquefied by the condenser 30. The refrigerant having been subjected to the heat exchange is decompressed by an expansion valve (not illustrated), passes through the pipe, and flows into the evaporator 50. Meanwhile, the air sent from the axial fan 60 to the condenser 30 is subjected to a heat exchange while passing the condenser 30, and flows out of an exhaust port 11 provided in the case 10.

### <Evaporator 50>

The evaporator 50 is configured to vaporize the refrigerant having been decompressed by the expansion valve (not illustrated). The evaporator 50 is a heat exchanger configured to perform a heat exchange between the refrigerant having been decompressed by the expansion valve and the air sent from the axial fan 60.

The heat of the air sent from the axial fan 60 to the evaporator 50 is absorbed into the refrigerant flowing in the evaporator 50, and therefore the air is cooled. The cooled air flows out from an opening 12 provided in the case 10 to an air conditioning duct 110. The air having flowed to the air conditioning duct 110 is blown as cool air to, for example, a vehicle compartment. The refrigerant having been subjected to the heat exchange in the evaporator 50 passes through the pipe and flows into the compressor 20. The refrigerant having flowed into the compressor 20 is compressed again. This circulation is repeated.

### <Axial Fan 60>

The axial fan 60 is configured to take in the air from a suction port (not illustrated) provided in the case 10, and send the air through a fan duct 80. In addition, the axial fan 60 is disposed on one side of the arrangement direction of the condenser 30 and the evaporator 50, and configured to supply the air to the condenser 30 and the evaporator 50.

Here, the air sent from the axial fan 60 is distributed between the condenser 30 and the evaporator 50 through the fan duct 80 having a shape described later. In addition, with the present embodiment, the axial fan 60 is rotated to allow the air to be blown out clockwise when the axial fan 60 is viewed from the evaporator 50 (hereinafter, referred to as “in the front view”).

Here, as illustrated in FIG. 1 and FIG. 2, the condenser 30 is disposed in the lower part, and the evaporator 50 is disposed in the upper part. That is, the condenser 30 and the evaporator 50 are arranged in the direction orthogonal to the air flow direction of the axial fan 60.

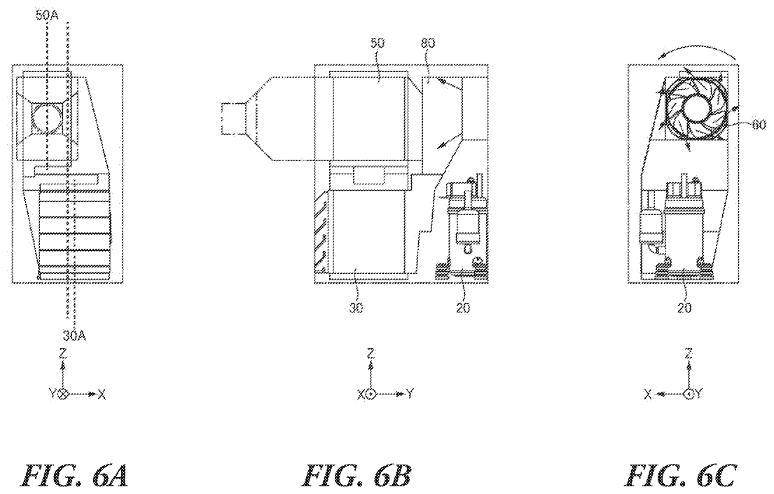

With the present embodiment, the evaporator 50 is disposed on the left side and the condenser 30 is disposed on the right side in the front view. That is, in the front view, a central axis 50A (see FIG. 6) of the evaporator 50 in the up-and-down direction and a central axis 30A (see FIG. 6) of the condenser 30 in the up-and-down direction are orthogonal to the air flow direction of the axial fan 60 and parallel to the vertical direction, and are spaced from one another. In addition, the central axis 50A of the evaporator 50 is disposed nearer the central axis of the axial fan 60 orthogonal to the air flow direction and parallel to the vertical direction, than the central axis 30A of the condenser 30. Moreover, the central axis 30A of the condenser 30 is disposed upstream from the central axis 50A of the evaporator 50 with respect to the rotation direction of the axial fan 60.

As described above, the axial fan 60 is rotated clockwise in the front view (counterclockwise in a rear view as FIG. 6(c)). By this means, the condenser 30 and the evaporator 50 are arranged such that the central axis 30A of the condenser 30 which is the heat exchanger far from the axial fan 60 is disposed upstream of the central axis 50A of the evaporator 50 which is the heat exchanger close to the axial fan 60 with respect to the rotation direction of the axial fan 60 (details of the air flow with this arrangement will be described later).

As described above, the condenser 30 is disposed in the lower part and the evaporator 50 is disposed in the upper part of the air conditioning apparatus 1. In addition, the axial fan 60 is provided in the upper part on the one side of the arrangement direction of the condenser 30 and the evaporator 50, and the fan duct 80 is disposed between the axial fan 60, and the condenser 30 and the evaporator 50. Moreover, the compressor 20 is provided under the axial fan 60, and a part of which is provided under the fan duct 80 and another part of which is provided on the axial fan 60 side. Therefore, the components (the compressor 20, the condenser 30, the evaporator 50, the axial fan 60, and the fan duct 80) are accommodated in the case 10 with a little dead space, and consequently the air conditioning apparatus 1 is compacted.

### <Inverter Device 70>

The inverter device 70 is configured to convert and output the voltage and the frequency of the power supplied from a power source, and, for example, controls the number of rotations of a motor driving the compressor 20.

In addition, the inverter device 70 includes an inverter board (heat releasing device) 71, and an inverter (heating element) 72 mounted on the inverter board 71, and is provided in the middle of the fan duct 80 (details will be described later). That is, the inverter board 71 is mounted in the middle of the fan duct 80.

The inverter 72 is a heating element whose temperature increases to a high level, and the inverter board 71 is a heat releasing device to release the heat generated from the inverter 72. Accordingly, the inverter board 71 is provided in the middle of the fan duct 80 which is a ventilation flue, and therefore it is possible to cool the inverter device 70 by the air sent from the axial fan 60.

### <Fan Duct 80>

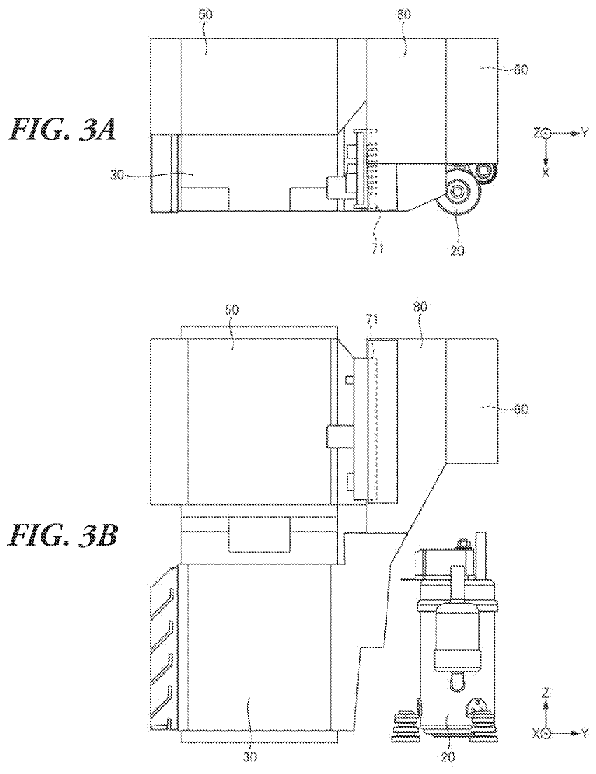

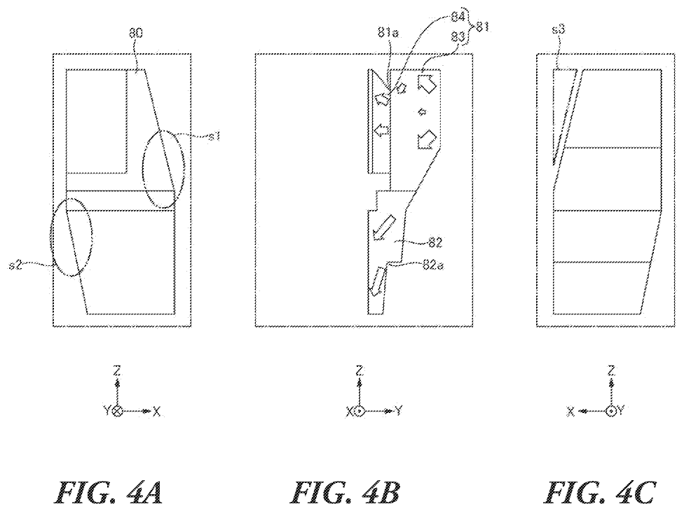

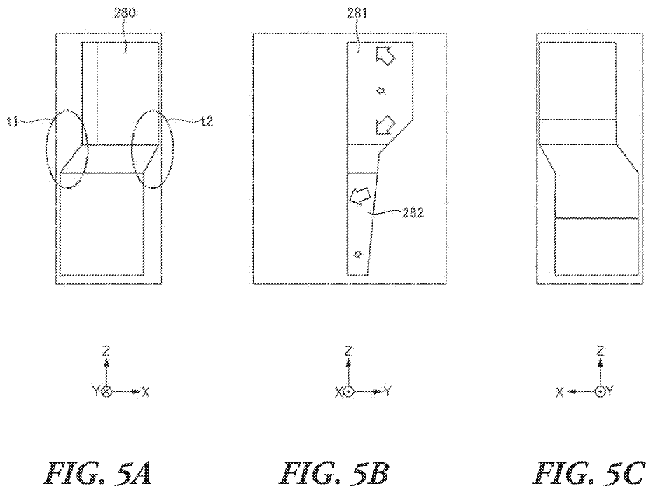

The fan duct 80 is configured to direct the air sent from the axial fan 60 to each of the condenser 30 and the evaporator 50. Hereinafter, the shape of the fan duct 80 will be described with reference to FIG. 3 and FIG. 4. In addition, FIG. 5 illustrates a comparative example with the difference in the shape of the fan duct 80.

As illustrated in FIG. 4A, the fan duct 80 includes a ventilation flue which is increased in length in the up-and-down direction and increased in size from upper left to lower right in the front view. In addition, as illustrated in FIG. 4B, the fan duct 80 includes an upper duct 81 and a lower duct 82. Here, a fan duct 280 as a comparative example illustrated in FIG. 5 includes an upper duct 281 and a lower duct 282.

The upper duct 81 is provided between the axial fan 60 and the evaporator 50 and between the axial fan 60 and the lower duct 82, and configured to send the air directly from the axial fan 60. The air sent to the upper duct 81 flows into the evaporator 50 and the lower duct 82.

In addition, the upper duct 81 includes a protrusion (one-side rectifier) 81a formed on the upper end surface of the fan duct 80. The protrusion 81a is provided between the axial fan 60 and the evaporator 50 and configured to protrude from the evaporator 50 side to the condenser 30 side. Here, as to the amount of air sent from the axial fan 60, the amount of the air going to the outer circumferential direction is greater than the amount of the air going straight from the center. Therefore, as to the amount of air sent from the axial fan 60, the amount of the air sent to the radial direction of the axial fan 60 (the upper left direction and the lower left direction in FIG. 4B) is greater than the amount of the air sent to the rotation axis direction of the axial fan 60.

In this way, the protrusion 81a is provided in the upper duct 81, and therefore the large amount of air sent upward from the axial fan 60 is pushed down, and by this means, it is possible to uniformize the wind speed distribution of the air flowing to the evaporator 50. On the other hand, in the case where the upper duct 281 does not include the protrusion 81a in the comparison example illustrated in FIG. 5, the amount of air sent upward is large, but the amount of air sent to the rotation axis direction of the axial fan 60 is small, and therefore it is not possible to uniformly deliver the air to the evaporator 50.

In addition, the inverter board 71 is mounted to the upper duct 81 between the axial fan 60 and the evaporator 50. To be more specific, the inverter board 71 is mounted to be inserted into the upper duct 81 of the fan duct 80, and the part of the inverter 71 and the mounting part of the inverter 72 are exposed to the outside of the fan duct 80. The air passing through the location in which the inverter 71 is provided flows to the condenser 30 side, and hardly flows to the evaporator 50 side. That is, the inverter board 71 is provided on the windward side of the evaporator 50, and the air having the heat from the inverter board 71 hardly flows to the evaporator 50, and therefore does not warm the air cooled by evaporator 50.

By this means, in the inverter device 70, the inverter board 71 as a heat releasing device is cooled by the air flowing in the fan duct 80, and therefore the inverter 72 can be adequately cooled. In addition, the air having been subjected to a heat exchange with the condenser 30 is warmed by the condenser 30, and therefore it is no problem that the air flowing to the condenser 30 is warmed a little by the inverter board 71. Therefore, it is possible to cool the inverter 72 while preventing the fan duct 80 from being overheated, and also preventing the air sent to the evaporator 50 from being warmed. Here, other than the inverter board 71, a board which does not generate heat or generates a small amount of heat may be provided in a space on one side of the evaporator 50 above the condenser 30.

The upper duct 81 includes an upper rear duct 83 and an upper front duct 84. The upper rear duct 83 covers an area from the axial fan 60 to around the rear end of the protrusion 81a, and the upper front duct 84 covers an area from around the rear end of the protrusion 81a to the evaporator 50.

The upper rear duct 83 is narrowed by the protrusion 81a, and the air sent upward from the axial fan 60 flows into the upper front duct 84. The upper front duct 84 has a structure in which the upper part is enlarged from the rear end to the front side (see FIG. 4B), and therefore the air flowing into the upper front duct 84 uniformly spreads and is delivered to the evaporator 50.

Meanwhile, the lower part of the upper rear duct 83 is enlarged from the upstream side to the downstream side (see FIG. 4B), and therefore the air sent downward from the axial fan 60 is efficiently delivered to the lower duct 82.

The lower duct 82 is provided between the upper duct 81 (upper rear duct 83) and the condenser 30. The upstream side of the lower duct 82 is connected to the upper duct 81, and the downstream side of the lower duct 82 is connected to the condenser 30. In addition, a restrictor (other-side rectifier) 82a is provided on the rear end side of the lower duct 82.

On the other hand, the lower duct 282 in the comparison example illustrated in FIG. 5 does not include the restrictor 82a. In this way, when the restrictor 82a is not provided, the amount of air in the upper part of the lower duct 282 is smaller than in the lower part. Consequently, it is not possible to uniformly deliver the air to the condenser 30.

In contrast, the lower duct 82 according to the present embodiment includes the restrictor 82a, and therefore the air flowing into the lower duct 82 from above is restricted by the restrictor 82a, so that the amount of air flowing downward from the restrictor 82a is decreased. In this way, the restrictor 82a is provided in the lower duct 82, and therefore it is possible to prevent a large amount of air from flowing to the lower part of the lower duct 82, and consequently to achieve uniform distribution of the air flowing to the condenser 30.

In addition, the fan duct 80 is enlarged around at seams between the upper duct 81 and the lower duct 82 as s1 and s2 illustrated in FIG. 4. Meanwhile, the upper part of the fan duct 80 is not always enlarged as s3 illustrated in FIG. 4. That is, the fan duct 80 is formed such that the upper part lies in the left side, and the lower part lies in the right side. In this way, the fan duct 80 is enlarged around at the seams between the upper duct 81 and the lower duct 82, and therefore it is possible to sufficiently distribute the air sent from the axial fan 60 downward.

In contrast, the fan duct 280 of the comparative example illustrated in FIG. 5 is formed such that the fan duct 280 is not enlarged at portions t1 and t2, the width of the upper duct 281 and the lower duct 282 is constant in the upper-and-lower direction, and the areas around the seams have the same width and are inclined. Therefore, it is not possible to sufficiently flow the air from the upper duct 281 to the lower duct 282, and consequently not possible to distribute a desired amount of air to the condenser 30.

Next, the rotation direction of the axial fan 60, and the layout of the condenser 30 and the evaporator 50 will be described.

As illustrated in FIG. 6, and as described above, the axial fan 60 is rotated clockwise in the front view. In the front view, the evaporator 50 is disposed on the left side, and the condenser 30 set under the evaporator 50 is disposed on the right side. Hereinafter, the right and the left mean the right and the left in the front view unless otherwise noted. That is, the axial fan 60 is rotated clockwise in the front view, and therefore the lower part of the axial fan 60 is rotated from right to left.

In this case, the condenser 30 provided under the axial fan 60 is disposed on the more right side than the evaporator 50, that is, disposed on the upstream side. The right part of the axial fan 60 is rotated from top to bottom. In addition, as described above, the fan duct 80 is formed such that the upper part lies in the left side and the lower part lies in the right side, and is enlarged around at the seams between the upper duct 81 and the lower duct 82. Therefore, it is possible to sufficiently deliver the air released downward from the right part of the axial fan 60 to the condenser 30 via the lower duct 82.

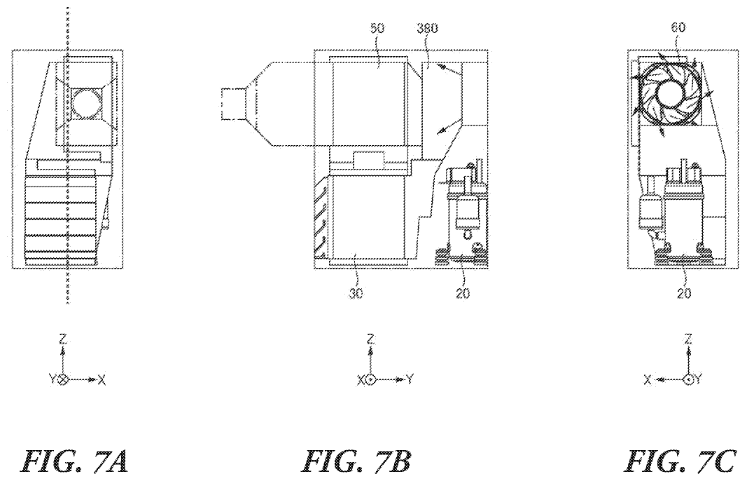

On the other hand, with the comparative example illustrated in FIG. 7, the evaporator 50 is disposed on the right side, and the condenser 30 set below the evaporator 50 is disposed on the left side. The axial fan 60 is rotated clockwise in the front view in the same way as the present embodiment (illustrated in FIG. 6), and therefore the right part of the axial fan 60 is rotated from top to bottom.

However, the evaporator 50 lies in the right side, and the space on the upper right side of the fan duct 380 is narrowed, and therefore the momentum of the air sent from the axial fan 60 is lost. Consequently, it is not possible to sufficiently send the air in a desired direction. Accordingly, the air sent from the axial fan 60 cannot reach the condenser 30 via the lower duct 82, and therefore it is not possible to deliver sufficient air to the condenser 30. That is, as the present embodiment, the condenser 30 and the evaporator 50 are arranged depending on the rotation direction of the axial fan 60, and therefore it is possible to effectively utilize the air sent from the axial fan 60.

In this way, in the air conditioning apparatus 1, the axial fan 60 sends the air into the fan duct 80 from the upstream side to the downstream side. In this case, the amount of air flowing to the rotation axis direction of the axial fan 60 is small, but the amount of air flowing to the radial direction of the axial fan 60 is large.

The large amount of air flowing upward is directed downward by the protrusion 81a of the fan duct 80, passes through the upper rear duct 83 and the upper front duct 84, and is uniformly supplied to the evaporator 50. The air supplied to the evaporator 50 is cooled in the evaporator 50, and the cooled air is supplied to the air conditioning duct 110. Meanwhile, part of the air sent from the axial fan 60 is delivered to and cools the inverter board 71, and therefore it is possible to cool the inverter 72.

On the other hand, the air sent downward from the axial fan 60 is supplied from the upper duct 81 to the lower duct 82. In this case, the air is sufficiently delivered downward by the restrictor 82a of the lower duct 82, and uniformly supplied to the condenser 30. The air supplied to the condenser 30 is subjected to a heat exchange with the refrigerant in the condenser 30, and therefore is heated, and then is discharged from the exhaust port 11 of the case 10.

As described above, according to the air conditioning apparatus 1 of the present embodiment, it is possible to arrange the components (the compressor 20, the condenser 30, the evaporator 50, and the axial fan 60) without a dead space to compact the apparatus, while distributing the air both the two heat exchangers (the condenser 30 and the evaporator 50) at a predetermined ratio by the one axial fan 60, and therefore the air can be uniformly passed through the heat exchangers.

In addition, according to the present embodiment, in addition to the layout of the components, the air conditioning apparatus 1 includes the fan duct 80 having the predetermined shape with the protrusion 81a and the restrictor 82a, and therefore it is possible to adjust the air distribution between the two exchangers (the condenser 30 and the evaporator 50) as intended.

Moreover, according to the present embodiment, in addition to the shape of the fan duct 80, the air conditioning apparatus 1 includes the inverter board 71 disposed in the enlarged portion of the fan duct 80, and therefore, it is possible to cool the inverter 72 without warming the air cooled by the evaporator 50.

Here, with the present embodiment, the axial fan 60 is rotated clockwise, the evaporator is disposed on the left side, and the condenser 30 is disposed on the right side in the front view. However, this is by no means limiting, but the axial fan 60 may be rotated counterclockwise, the evaporator 50 may be disposed on the right side, and the condenser 30 may be disposed on the left side.

### REFERENCE SIGNS LIST

1 air conditioning apparatus
10 case
11 exhaust port
12 opening
20 compressor
30 condenser (heat exchanger)
50 evaporator (heat exchanger)
60 axial fan
70 inverter device
71 inverter board (heat releasing device)
72 inverter (heating element)
80, 280, 380 fan duct (ventilation flue)
81, 281 upper duct
81a protrusion (one-side rectifier)
82, 282 lower duct
82a restrictor (other-side rectifier)
83 upper rear duct
84 upper front duct
110 air conditioning duct

1. An air conditioning apparatus comprising:
a refrigerant circuit including a plurality of heat exchangers; and
an axial fan configured to send air to the heat exchangers, the refrigerant circuit and the axial fan being accommodated in a case, wherein:
the heat exchangers are disposed in a direction orthogonal to an air flow direction; and
the axial fan is disposed on one side of an arrangement direction of the heat exchangers, and supplies the air to the heat exchangers.

2. The air conditioning apparatus according to claim 1, further comprising a one-side rectifier configured to uniformize wind speed distribution of air flowing to a heat exchanger on the one side of the arrangement direction.

3. The air conditioning apparatus according to claim 2, wherein the one-side rectifier is a protrusion formed on the one side of the arrangement direction of an end surface of a flow path of the air flowing from the axial fan to the heat exchanger on the one side of the arrangement direction, the protrusion protruding to the other side of the arrangement direction.

4. The air conditioning apparatus according to claim 1, further comprising an other-side rectifier configured to uniformize wind speed distribution of air flowing to a heat exchanger on the other side of the arrangement direction.

5. The air conditioning apparatus according to claim 4, wherein the other-side rectifier includes a restrictor configured to narrow a flow path of the air flowing from the axial fan to the heat exchanger on the other side of the arrangement direction.

6. The air conditioning apparatus according to claim 1, wherein a central axis of the heat exchanger on the one side of the arrangement direction and a central axis of the heat exchanger on the other side of the arrangement direction are orthogonal to the air flow direction and parallel to a vertical direction, and are spaced from one another.

7. The air conditioning apparatus according to claim 6, wherein the central axis of the heat exchanger on the one side of the arrangement direction is disposed nearer a central axis of the axial fan orthogonal to the air flow direction and parallel to the vertical direction than the central axis of the heat exchanger on the other side of the arrangement direction.

8. The air conditioning apparatus according to claim 1, further comprising:
a heating element; and
a heat releasing device mounted to the heating element,
wherein the heat releasing device is provided in a ventilation flue through which air being subjected to a heat exchange with the heat exchangers, on a windward side of the heat exchangers.

9. The air conditioning apparatus according to claim 8, wherein the heat releasing device is provided in the ventilation flue of the heat exchanger on the one side of the arrangement direction.

10. The air conditioning apparatus according to claim 2, further comprising an other-side rectifier configured to uniformize wind speed distribution of air flowing to a heat exchanger on the other side of the arrangement direction.

11. The air conditioning apparatus according to claim 3, further comprising an other-side rectifier configured to uniformize wind speed distribution of air flowing to a heat exchanger on the other side of the arrangement direction.

12. The air conditioning apparatus according to claim 2, wherein a central axis of the heat exchanger on the one side of the arrangement direction and a central axis of the heat exchanger on the other side of the arrangement direction are orthogonal to the air flow direction and parallel to a vertical direction, and are spaced from one another.

13. The air conditioning apparatus according to claim 3, wherein a central axis of the heat exchanger on the one side of the arrangement direction and a central axis of the heat exchanger on the other side of the arrangement direction are orthogonal to the air flow direction and parallel to a vertical direction, and are spaced from one another.

14. The air conditioning apparatus according to claim 4, wherein a central axis of the heat exchanger on the one side of the arrangement direction and a central axis of the heat exchanger on the other side of the arrangement direction are orthogonal to the air flow direction and parallel to a vertical direction, and are spaced from one another.

15. The air conditioning apparatus according to claim 5, wherein a central axis of the heat exchanger on the one side of the arrangement direction and a central axis of the heat exchanger on the other side of the arrangement direction are orthogonal to the air flow direction and parallel to a vertical direction, and are spaced from one another.

16. The air conditioning apparatus according to claim 2, further comprising:
a heating element; and
a heat releasing device mounted to the heating element,
wherein the heat releasing device is provided in a ventilation flue through which air being subjected to a heat exchange with the heat exchangers, on a windward side of the heat exchangers.

17. The air conditioning apparatus according to claim 3, further comprising:
a heating element; and
a heat releasing device mounted to the heating element,
wherein the heat releasing device is provided in a ventilation flue through which air being subjected to a heat exchange with the heat exchangers, on a windward side of the heat exchangers.

18. The air conditioning apparatus according to claim 4, further comprising:
a heating element; and
a heat releasing device mounted to the heating element,
wherein the heat releasing device is provided in a ventilation flue through which air being subjected to a heat exchange with the heat exchangers, on a windward side of the heat exchangers.

19. The air conditioning apparatus according to claim 5, further comprising:
a heating element; and
a heat releasing device mounted to the heating element,
wherein the heat releasing device is provided in a ventilation flue through which air being subjected to a heat exchange with the heat exchangers, on a windward side of the heat exchangers.

20. The air conditioning apparatus according to claim 6, further comprising:
a heating element; and
a heat releasing device mounted to the heating element,
wherein the heat releasing device is provided in a ventilation flue through which air being subjected to a heat exchange with the heat exchangers, on a windward side of the heat exchangers.
